(19) United States
(12) Patent Application Publication
(10) Pub. No.: US 2005/0039982 A1
(43) Pub. Date: Feb. 24, 2005

(54) Rescue system

(76) Inventor: Gunni Allan Jensen, Jerslev (DK)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/493,431

(22) PCT Filed: Oct. 28, 2002
(86) PCT No.: PCT/DK02/00716

(30) Foreign Application Priority Data
Oct. 26, 2001 (DK) PA 2001 01586

(51) Int. Cl. A62B 37/00

(52) U.S. Cl. 182/82

(57) ABSTRACT

There is described a rescue system including a profile rail (2) adapted for securing in mainly vertical position either externally of a building (4) or to be incorporated in an outer wall of a building in connection with rescue apertures on respective storeys, the profile rail (2) having an outwards open vertical slot (10) and external and internal contact faces (14,16) at both sides of said slot (10), and a number of lowering devices (12) with associated rescue harnesses (20), where each lowering device includes upper transverse coupling and connecting means (22) arranged to be inserted in the profile rail (2) and be fixed in this by turning the lowering device (12) downwards and by inserting and fixing a lower guide part of this in the vertical slot (10), the guide part including a fixing device arranged to interact with internal edge parts of the said slot of the profile rail, where each lowering device (12) includes a suspending part with a hook part or an eyelet for connecting with a hook part or an eyelet of the rescue harness (20), and where each lowering device (12) includes brake means (24, 26) arranged for interacting with said internal or external contact surfaces (14, 16) of the profile rail (2). By means of simple measures, it is hereby possible to achieve a very simple and optimally functioning rescue system of the kind concerned in practice.

### FIELD OF THE INVENTION

The present invention concerns a rescue system of the kind indicated in the preamble of claim 1.

### TECHNICAL BACKGROUND OF THE INVENTION

There are known rescue systems of this kind where one is working with rescue ropes in the form of a rope or a wire and different braking systems, as the rope or wire is fastened opposite to or above the point of escape. Other known rescue systems of this kind works with a permanent profile rail which is fitted externally of a building, and which interacts with special lowering systems.

U.S. Pat. No. 4,083,438 describes e.g. an escape or lowering device for use in case of fire in hotels and other buildings and for use as safety device when working on high places. The lowering device is used in connection with a single rope and has such design that the rope is always actutated by a person's weight and thereby actuated to provide braking for controlling the speed of lowering. The action of the said braking may be cancelled by means of a releasing mechanism with a release arm. During the lowering, the person is fixed by means of a belt and a strap connected with the device.

U.S. Pat. No. 4,576,248 describes a rescue and safety device for use by persons working at great height from which they risk to fall. The device includes a braking device through which a rope is passed in such a way that it is automatically squeezed for braking the falling person to which the device is fastened, as the rope is fastened in the height in which the person works, or possibly at still greater height. The device includes a release arm that is to be moved downwards for releasing the brake action of the device, i.e. for controlling the lowering of a person hanging in the device.

WO 28/00006 describes an escape apparatus for use in case of fire and comprising a vertically running section that defines a canal with flanges which defines a front wall of the canal section and forming an open slot between them. Inside the canal section, rows of mutually staggered projections are formed between the flanges and a rear wall. A harness for supporting a fleeing person in case of fire or other emergency is suspended in a T-shaped brace comprising a transverse part and an upright part. In the situation of use, the transverse part and the upright part in the canal section are inserted through the slot so that a lower projecting part of the upright part protrude through the slot and is thereby guided laterally in the latter as the harness brace moves downwards under the weight of the fleeing person as the transverse part, by alternating interaction with the projections at each their side of the canal (like a tumbler) performs a rocking movement.

U.S. Pat. No. 4,629,032 describes a lowering device that interacts with a profile rail, which is permanently mounted on an outer wall of a high building, and which comprises a manual braking device. The latter includes rollers with contact surfaces with peripheral indentations that grip around edge parts of flanges of the profile beam, the lowering device having a suspension for a rescue harness and a manually controlled braking device that interacts with one of the said flange edge parts of the profile beam.

U.S. Pat. No. 4,709,782 describes a fire escape device for high-rise blocks, acting by gravitational force and particularly adapted for use in high-rise buildings and modern skyscrapers as an escape device from any floor of the building for rescuing an employee or worker who has been caught and prevented from using the usual stairs or elevator due to e.g. fire, electrical or supply disturbances, collapse of building or personal damage of the employee etc.

On this background, it is the purpose of the invention to provide a new and improved rescue system of the kind mentioned in the introduction, and which by means of simple measures enables to achieve a very simple and optimal function of the rescue system in practice.

### SUMMARY OF THE INVENTION

The rescue system according to the invention is peculiar in that each lowering device includes upper transverse coupling and connecting means arranged to be inserted in the profile rail and be fixed in this by turning the lowering device downwards and by inserting and fixing a lower guide part of this in the vertical slot, the guide part including a fixing device arranged to interact with internal edge parts of the said slot of the profile rail, that each lowering device includes a suspending part with a hook part or an eyelet for connecting with a hook part or an eyelet of the rescue harness, and that each lowering device includes brake means arranged for interacting with said internal or external contact surfaces of the profile rail. By means of simple measures, it is hereby possible to achieve a very simple and optimally functioning rescue system of the kind concerned in practice.

The rescue system according to the invention is suitably designed so that the brake means of each of said lowering devices are constituted by an upper set of brake shoes and a lower set of brake shoes arranged to abut on the profile rail at both sides of the vertical slot, which brake shoes are arranged to brake the lowering device when a person is suspended in the suspending part, as each lowering device includes a separate control rod system with a regulating arm connected with the rescue harness by means of a separate strap, and which is arranged to regulate the brake pressure between said lower set of brake shoes and the profile rail.

Preferably, the rescue system according to the invention is further designed so that said upper set of brake shoes together with said coupling and connecting means are arranged to brake the lowering device when it is ready to be connected with a fleeing person by means of the rescue harness, i.e. when the lowering device is connected with and fixed to the profile rail.

The rescue harness for the rescue system according to the invention may with particular advantage be made up of strong straps, e.g. of canvas, and includes a first strap section adapted to be put around the waist and which is closed with a snap buckle, thigh straps originating from first strap section with mutual spacing, and which are arranged to be inserted between the legs and fastened by means of a common snap hook to a connecting member, e.g. a ring, close to the snap buckle, and by a carrier strap with snap hook arranged to be connected to the hook part or eyelet of the suspension part of the lowering device.

With particular advantage, the rescue system according to the invention may be designed so that the rescue harness also includes the separate strap arranged to be connected with the regulating arm for the brake means of the lowering device, and which has a special marking colour, e.g. red or yellow.

In a preferred embodiment, the rescue system according to the invention is designed so that the fixing device includes a double-sided pawl arranged to be released by insertion of the lower control part into the vertical slot, so that the pawl bears against the internal edge parts of the slot of the profile rail.

Preferably, the rescue system according to the invention is further designed so that the pawl is constituted by a pivotable pawl journalled about an axis of pivot and which by means of a spring is pressed against an actuation plate including an upwards directed actuating arm with a transverse actuation part, and which is arranged to press the pivotable pawl forwards so that it is situated opposite to lateral cut-outs in the control part, i.e. so that the pivoting pawl is allowed to pivot outwards and to get hold behind the internal edge parts of the vertical slot in the profile rail.

In order to ensure optimal function of the pivoting pawl, the rescue system according to the invention is designed so that between the actuating plate and the pivoting plate there is inserted a spring arranged to provide the pawl with an initial pivoting moment when the pawl is placed opposite to the lateral cut-outs.

In a preferred embodiment, the rescue system according to the invention is designed so that the pivoting pawl is designed and suspended so that it automatically under the influence of the force of gravity is swung out when the pawl by actuation of the actuation plate is pressed forwards and placed opposite to the lateral cut-outs.

Suitably, the rescue system according to the invention is furthermore designed so that the said upper set of brake shoes is mounted on carrier plates at each side of a central part of the lowering device, the carrier plates being connected with the central part by means of upper and lower journaling rods, of which lower journaling rods have been passed through journaling boring in the central part whereas upper journaling rods, with a certain freedom of movement, have been passed through holes in the central part and are spring biased inwards against the profile rail. In a simple way is hereby achieved an almost optimal abutment of the upper brake shoes against the outer side of the profile rail, so that the upper brake shoes safely may hold an unloaded lowering device on the profile rail in a ready position, i.e. before a fleeing person couples his rescue harness to the lowering device.

### SHORT DESCRIPTION OF THE DRAWING

The invention will be explained in more detail in the following with reference to the drawing, in which:

FIG. 1A shows an embodiment of a profile rail for a rescue system according to the invention, as seen from one end,

FIG. 1B shows the profile rail, cf. FIG. 1A, from the front,

FIG. 2 shows a schematic draft for illustrating the functioning of the rescue system according to the invention,

FIG. 3 shows a side view of test version of a lowering device for the rescue system according to the invention,

FIG. 4 shows a perspective view of the lowering device shown in FIG. 3,

FIG. 5 shows a perspective view of a preferred embodiment of a lowering device for a rescue system according to the invention, shown in ready-for-use position on a profile rail,

FIG. 6 shows a side view of the lowering device shown in FIG. 5 with associated profile rail during insertion of a lower guide part thereof in the slot of the profile rail,

FIG. 7A shows a draft of a part of a guide element for lowering device for the rescue system according to the invention,

FIG. 7B shows a further draft of a guide element for a lowering device for the rescue system according to the invention,

FIG. 8 shows how the rescue system according to the invention is used in practice for lowering a person which in beforehand has been provided with a rescue harness with associated regulating strap, and

FIG. 9 shows an embodiment of a rescue harness for use in connection with lowering device for a rescue system according to the invention.

### DETAILED DESCRIPTION OF THE INVENTION

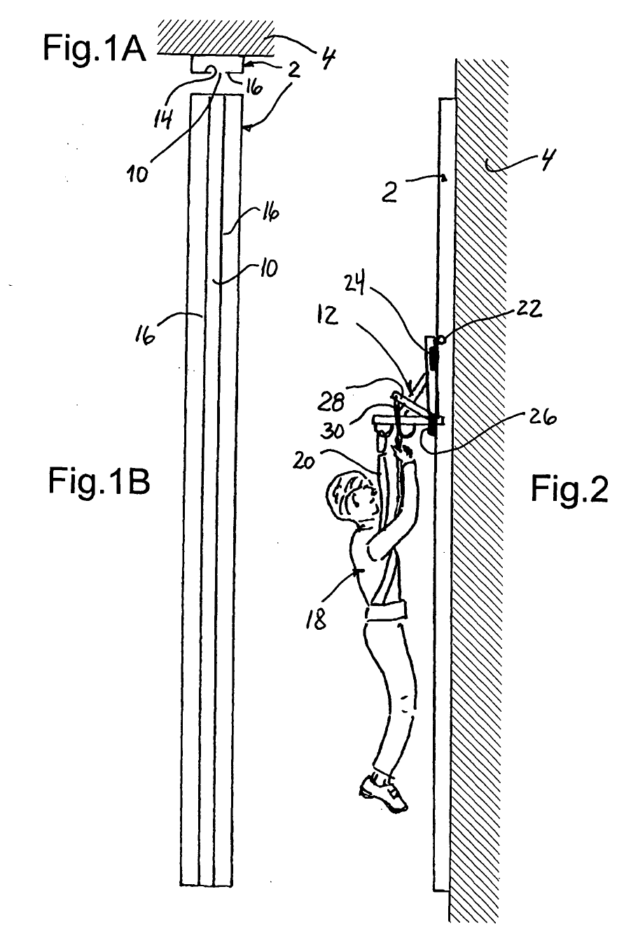

The profile rail 2 shown in FIGS. 1A and 1B is adapted to be fitted at the outer wall of a building 4 in such a way that the profile rail 2 passes close by a number of rescue apertures, e.g. windows, at respective storeys on the building which is a high building with several floors. The profile rail 2, which in principle may also be built into the outer wall of the building 4, has mainly rectangular cross-section with a closed rear side 6, which is bolted to the building 4, and a front side 8 with a vertical slot 10 with internal and external edge parts 14, 16 which a lowering device 12 (FIG. 2) may interact with when a fleeing person 18 suspended in a rescue harness 20 is to be rescued from an e.g. burning building.

The function of the rescue system according to the invention is illustrated in FIG. 2, where the fleeing person 18, by means of a rescue harness 20, is suspended in the lowering device 12 in such a way that the weight of the person 18 will automatically brake the lowering device 12, as this by means of transverse coupling and connecting means 22 inserted in the slot 10 and interacting with internal edge parts 14 thereof, while brake means 24 of the lowering device 12 interacts with external edge parts 16 of the profile rail 2. The braking function of lower brake means in the shape of brake shoes 26 is adapted to be regulated by means of a control rod system with a spring biased, projecting regulating arm 28, which is accessible for actuation by the fleeing person 18 by pulling of the regulating arm 28 by means of a special strap 30 which furthermore is connected with the rescue harness 20.

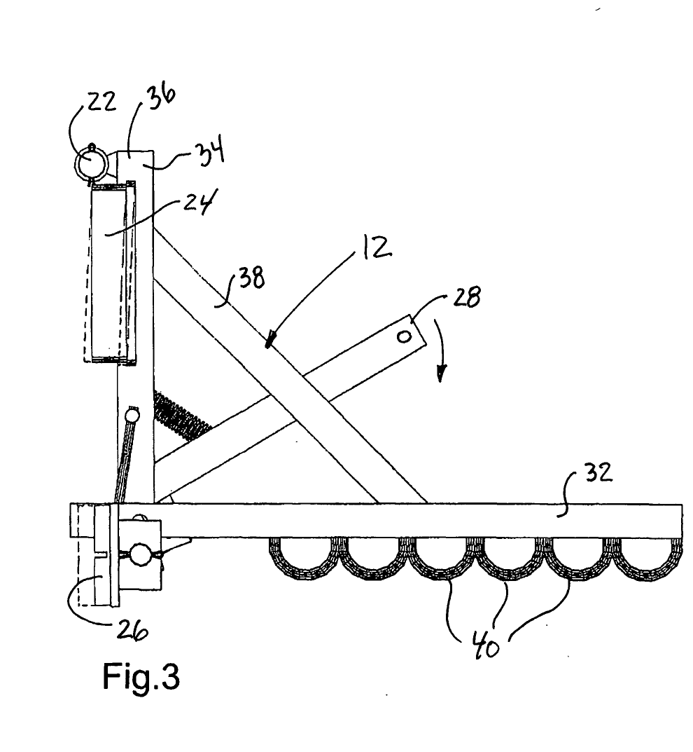

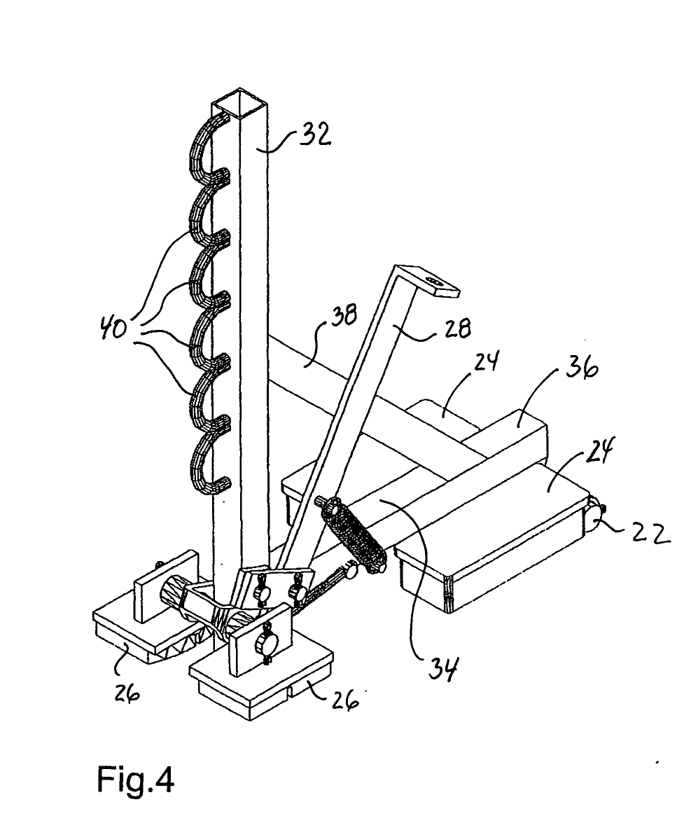

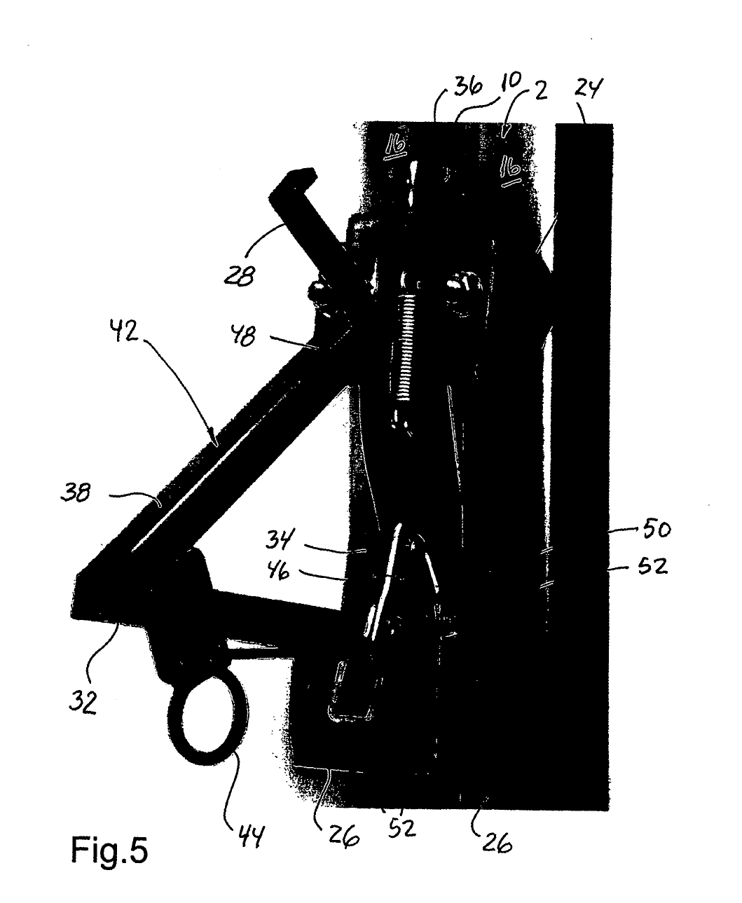

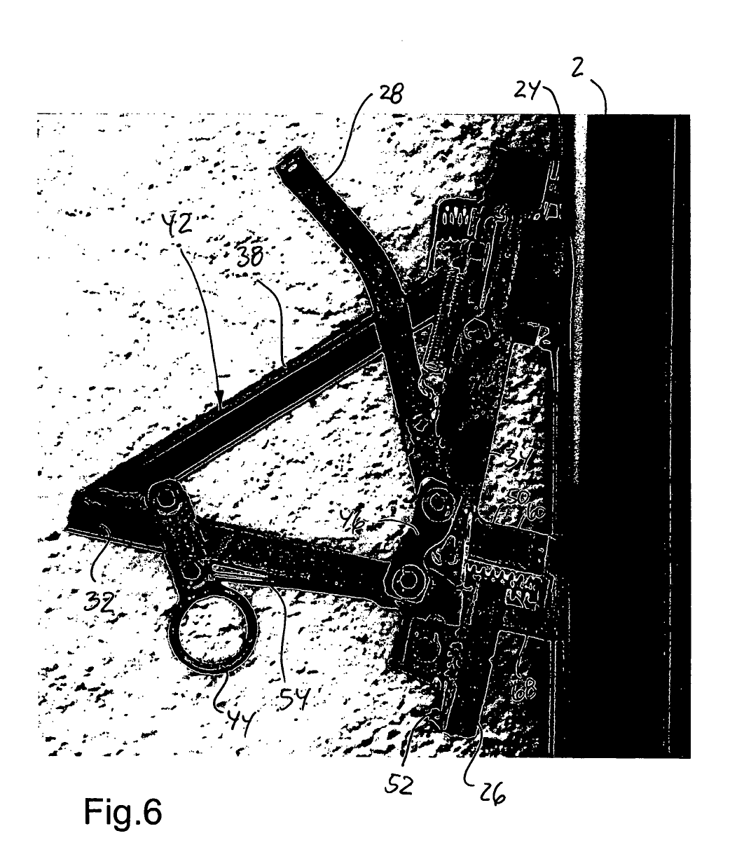

A special test version of the lowering device 12 is shown in FIGS. 3 and 4, where a projecting carrier arm 32 is directly connected with a base part 34, of which an upper part 36 is furthermore connected with the carrier arm 32 by means of an inclined brace 38. The carrier arm 32 is provided with a number of suspending eyelets 40 which are arranged for suspending a person with varying weight, as heavy persons are suspended close to the base part 34 whereas light persons are suspended in eyelets at greater distance from the base part 34. This principle of suspension has been abandoned subsequently, as a preferred lowering device 42, cf. FIGS. 5 and 6, only has one suspension eyelet 44, as one does not want the fleeing person to be further confused by having possibility of choosing between several suspension eyelets 40 in case of a rescue situation.

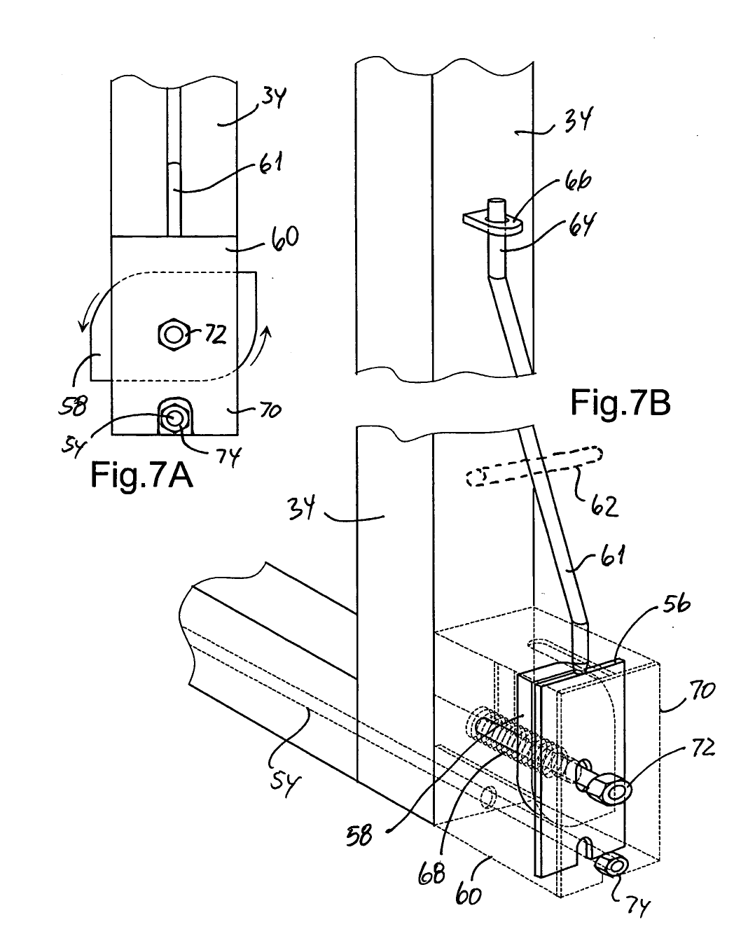

By the lowering device 42 shown in FIGS. 5 and 6 there are, where considered feasible, used the same reference numbers as above. Lower, movable brake shoes 26 interact with it in upwards direction by means of regulating arm 28 biased a spring 48 via a short intermediate member 46 so that the braking action of the brake shoes 26 is reduced by downward pull in the regulating arm 28. In order to counteract capsizing, the brake shoes 26 are held in position by means of a wire bracket 50 running through a hole in the base part 34 and downward through eyelets 52 fastened at the rear side of the brake shoes 26, at the top and at the bottom, respectively, of these. The suspension eyelet 44 is pivotably suspended in the carrier arm 32, as the suspending eyelet 44 is connected by means of a drawbar 54 to an actuating plate 56 (FIG. 7B) for a double sided swing pawl 58, which by insertion of a lower rearwards directed control part 60 of the lowering device 42 in the slot 10 of the profile rail 2 is arranged to be released so that the swing pawl 58 abuts on the said internal edge parts 14 of the profile rail 2. The drawbar 54 is to ensure that the pawl 58, after swinging out cf. the explanation below, remains in secure engagement with the profile rail 2 even though a fleeing person should choose to stem legs against the external wall during the lowering, so that an outward pull in the lowering device 42 occurs.

As shown in FIG. 7B, behind the pawl 58 there is disposed an actuation plate 56 having an upwards directed actuating arm 61 with a transverse actuating member 62. An upper free end part 64 of the actuating arm 61 is guided in an eyelet 66 which is fastened at the inner side of the base part 34. Before inserting the guide member 60 in the slot 10 of the profile rail 2, the pawl 58 and the actuation plate 56 are spring biased in direction away from the base part 34 by means of a compression spring 68, so that the pawl 58 is passed rearward in the guide member 60 and is disposed behind lateral cutouts in this, so that the pawl 58 is prevented from swinging out until the guide member 60, by the action of the actuation plate 56, has been pushed forward, which occurs in connection with the first inserting of the guide member 60 in the slot 10, as the actuation member 62 is thereby pressed against the front side of the profile rail 2, so that the actuation arm 61 is thereby pressed inwards and moves the pawl 58 forward to a position opposite to the said lateral cut-outs, whereby the pawl 58 is swung out remaining in the position shown in FIG. 7A, i.e. the guide member 60 and thereby the lowering device 42 are securely fixed in the profile rail 2. At the rear, the guide member 60 is provided with a cover 70 with associated nut 72. An internal end part of the drawbar 54 is connected with the actuating plate 56 by means of a nut 74.

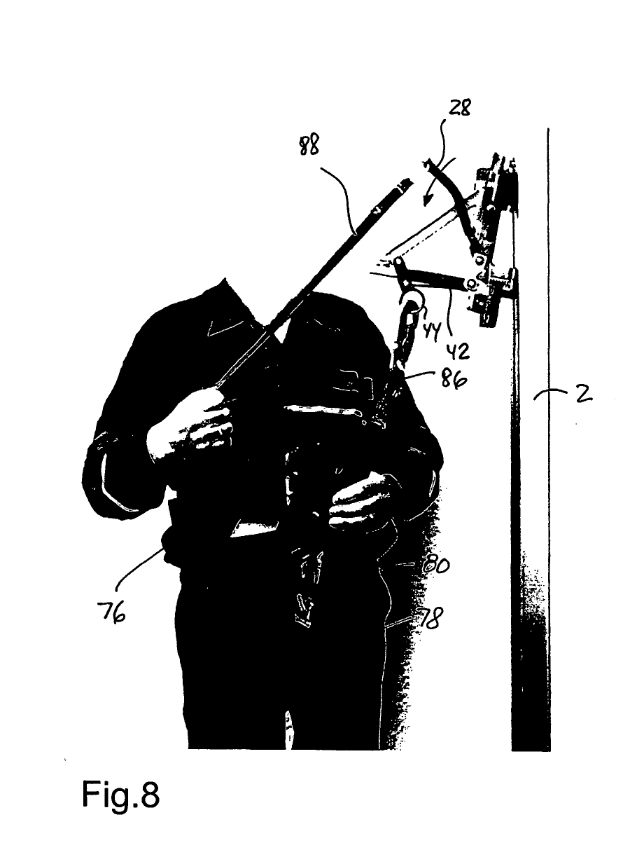

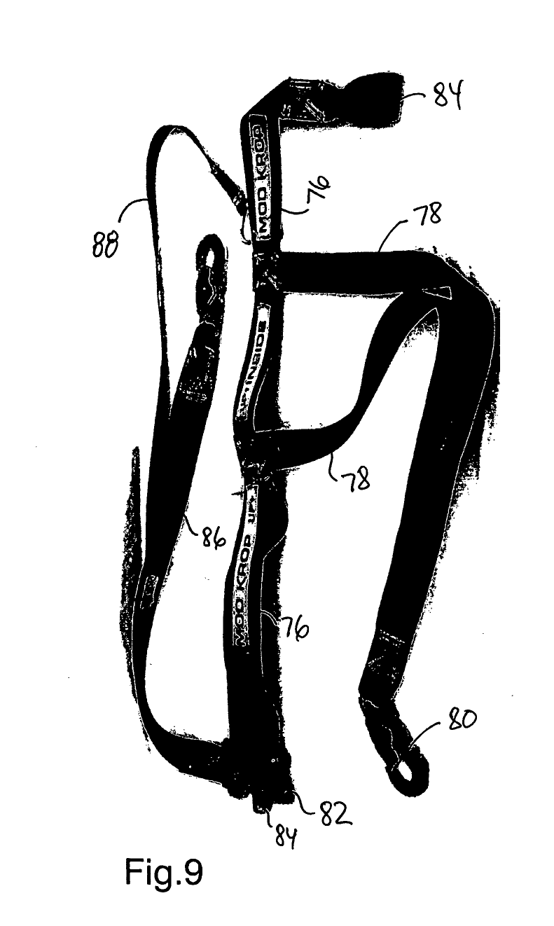

Furthermore, the rescue system according to the invention also concerns a rescue harness 20, which is shown most clearly in FIGS. 8 and 9. In FIG. 8, a person is ready to be lowered by means of a lowering device 42, the coupling and connecting means 22 of which have been inserted and fixed at the outer side of the profile rail 2. The person has put on the rescue harness 20 by dressing in a belt part 76 and by passing thigh straps 78 initiating from the rear side of the belt part 76 between the legs and by fastening a common snap hook 80 in a connecting eyelet 82 close to a snap buckle 84. When the rescue harness 20 has been correctly placed on the person, a carrier strap 86 with snap hook is connected to the suspending eyelet 44, and a separate adjusting strap 88 is finally connected to an outer eyelet of the regulating arm 28, after which the person is ready to lower himself by means of the lowering device 42.

During lowering, the brake function is released by the brake shoes 26 by a downward directed pull in the regulating arm 28 by means of the regulating strap 88, so that the person is lowered with desired speed. If a person loses consciousness during lowering, a person coming from above may release the brake by depressing the regulating arm on a lowering device braked below with the foot, so that all may come safely down by means of the rescue system.

At the end it is to be mentioned that the rescue system may of course be adapted to the actual conditions, i.e. it is to comprise the necessary number of lowering devices with associated rescue harnesses per floor. On each floor, the lowering devices are to be disposed optimally in an easily accessible way in the vicinity of the actual rescue aperture, as it is supposed that a building may comprise several rescue systems which preferably are all to be accessible from all floors, i.e. it may also be possible to operate with a plurality of rescue systems serving e.g. every second or every third floor.

1. A rescue system including a profile rail adapted for securing in mainly vertical position either externally of a building or to be incorporated in an outer wall of a building in connection with rescue apertures on respective storeys, the profile rail having an outwards open vertical slot and external and internal contact faces, preferably at both sides of said slot, and a number of lowering devices with associated rescue harnesses, characterised in that each lowering device includes upper transverse coupling and connecting means arranged to be inserted in the profile rail and be fixed in this by turning the lowering device downwards and by inserting and fixing a lower guide part of this in the vertical slot, the guide part including a fixing device arranged to interact with internal edge parts of the said slot of the profile rail, that each lowering device includes a suspending part with a hook part or an eyelet for connecting with a hook part or an eyelet of the rescue harness, and that each lowering device includes brake means arranged for interacting with said internal or external contact surfaces of the profile rail.

2. A rescue system according to claim 1, characterised in that said brake means of each of said lowering devices are constituted by an upper set of brake shoes and a lower set of brake shoes arranged to abut on the profile rail at both sides of the vertical slot, which brake shoes are arranged to brake the lowering device when a person is suspended in the suspending part, as each lowering device includes a separate control rod system with a regulating arm connected with the rescue harness by means of a separate strap, and which is arranged to regulate the brake pressure between said lower set of brake shoes and the profile rail.

3. A rescue system according to claim 1 and 2, characterised in that said upper set of brake shoes together with said coupling and connecting means are arranged to brake the lowering device when it is ready to be connected with a fleeing person by means of the rescue harness, i.e. when the lowering device is connected with and fixed to the profile rail.

4. A rescue system according to claim 1 and 2, characterised in that the rescue harness is made up of strong straps, e.g. of canvas, and includes a first strap section adapted to be put around the waist and which is closed with a snap buckle, thigh straps originating from first strap section with mutual spacing, and which are arranged to be inserted between the legs and fastened by means of a common snap hook to a connecting member, e.g. a ring, close to the snap buckle, and by a carrier strap with snap hook arranged to be connected to the hook part or eyelet of the suspension part of the lowering device.

5. A rescue system according to claims 1, 2 and 4, characterised in that the rescue harness also includes the separate strap arranged to be connected with the regulating arm for the brake means of the lowering device, and which has a special marking colour, e.g. red or yellow.

6. A rescue system according to claim 1, characterised in that the fixing device includes a double-sided pawl arranged to be released by insertion of the lower control part into the vertical slot, so that the pawl bears against the internal edge parts of the slot of the profile rail.

7. A rescue system according to claim 1 and 6, characterised in that the pawl is constituted by a pivotable pawl journalled about an axis of pivot and which by means of a spring is pressed against an actuation plate including an upwards directed actuating arm with a transverse actuation part, and which is arranged to press the pivotable pawl forwards so that it is situated opposite to lateral cut-outs in the control part, i.e. so that the pivoting pawl is allowed to pivot outwards and to get hold behind the internal edge parts of the vertical slot in the profile rail.

8. A rescue system according to claim 1, 6 and 7, characterised in that between the actuating plate and the pivoting plate there is inserted a spring arranged to provide the pawl with an initial pivoting moment when the pawl is placed opposite to the lateral cut-outs.

9. A rescue system according to claim 1, 6 and 7, characterised in that the pivoting pawl is designed and suspended so that it automatically under the influence of the force of gravity is swung out when the pawl by actuation of the actuation plate is pressed forwards and placed opposite to the lateral cut-outs.

10. A rescue system according to claim 1 and 2, characterised in that the said upper set of brake shoes is mounted on carrier plates at each side of a central part of the lowering device, the carrier plates being connected with the central part by means of upper and lower journaling rods, of which lower journaling rods have been passed through journaling boring in the central part whereas upper journaling rods, with a certain freedom of movement, have been passed through holes in the central part and are spring biased inwards against the profile rail.
